(19) United States
(12) Patent Application Publication
(10) Pub. No.: US 2024/0241970 A1
(43) Pub. Date: Jul. 18, 2024

(54) PROXIMITY-BASED DATA ACCESS CONTROL

(71) Applicant: International Business Machines Corporation, Armonk, NY (US)

(72) Inventors: Alfredo V. Mendoza, Georgetown, TX (US); Sahdevsinh P Zala, Cary, NC (US); Andrea Crawford, Fort Myers, FL (US)

(73) Assignee: International Business Machines Corporation, Armonk, NY (US)

(21) Appl. No.: 18/098,594

(22) Filed: Jan. 18, 2023

(51) Int. Cl. G06F 21/60

(52) U.S. Cl. CPC G06F 21/604

(57) ABSTRACT

An embodiment determines that a current location is within a threshold proximity to a proximity device and extracts a unique user identifier (UUID) from data received from the proximity device via a first type of network. The embodiment transmits an information request that includes the UUID and a role-based information control (RBIC) identifier to a remote access control system via a second type of network. The embodiment locally stores UUID information received in response to the information request. The UUID information is associated with the UUID and has been filtered based on the RBIC. The embodiment detects a change to the current location, determines that the current location exceeds the threshold proximity to the proximity device, and automatically deletes, responsive to determining that the current location exceeds the threshold proximity, the locally stored UUID information.

### BACKGROUND

The present invention relates generally to management of data. More particularly, the present invention relates to a method, system, and computer program for proximity-based data access control.

A computer network is a system that connects two or more computing devices to allow for the exchange of data and resources. The networked computing devices may be connected by cables (wired) or by radio frequency (RF) connections (wireless). Communication between the devices is enabled by networking hardware (e.g., routers, switches, access points, and cables) and software (e.g., operating systems and business applications).

There are many different types of computer network. A network type, as referred to herein, is one of the various known sizes of computer networks. The various known sizes of computer networks include Wide Area Networks (WANs), Local Area Networks (LANs), and Personal Area Networks (PANs). A WAN is a type of computer network that covers a relatively large geographical area, such as an entire city or country. A LAN is a type of computer network that covers a smaller area than a WAN and is usually confined to a single physical location such as an office or a building.

A PAN is a type of computer network that covers a smaller area than a LAN, usually about 30 meters or less. An example of a PAN includes devices connected by universal serial bus (USB) cables. An example of a wireless PAN (WPAN) includes devices connected by Bluetooth (BLUETOOTH® is a registered trademark of Bluetooth SIG, Inc., Kirkland, Wash., U.S.A.) or infrared wireless signals. A WPAN, as referred to herein, may also include radio frequency identification (RFID), which includes an active or passive tag that has an encoded identifier.

### SUMMARY

The illustrative embodiments provide for proximity-based data access control. An embodiment includes determining that a current location is within a threshold proximity to a proximity device. The embodiment also includes extracting a unique user identifier (UUID) from data received from the proximity device via a first type of network. The embodiment also includes transmitting an information request that includes the UUID and a role-based information control (RBIC) identifier to a remote access control system via a second type of network. The embodiment also includes storing, responsive to receiving UUID information in response to the information request, the UUID information on a computer readable storage medium, where the UUID information is associated with the UUID, and where the UUID information has been filtered based on the RBIC. The embodiment also includes detecting a change to the current location. The embodiment also includes determining that the current location exceeds the threshold proximity to the proximity device. The embodiment also includes deleting, automatically responsive to determining that the current location exceeds the threshold proximity, the UUID information from the computer readable storage medium. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example network architecture that includes an access control module in accordance with an illustrative embodiment;

FIG. 3 depicts a block diagram of an example service infrastructure in accordance with an illustrative embodiment;

FIG. 4 depicts a block diagram of an example of proximity-based and role-based access control in accordance with another illustrative embodiment;

FIG. 5 depicts a block diagram of an example of proximity-based and role-based access control in accordance with another illustrative embodiment;

FIG. 6 depicts a block diagram of an example of proximity-based and role-based access control in accordance with another illustrative embodiment;

FIG. 7 depicts a block diagram of an example of proximity-based and role-based access control in accordance with another illustrative embodiment;

FIG. 8 depicts a block diagram of an example of proximity-based and role-based access control in accordance with another illustrative embodiment;

FIG. 9 depicts a block diagram of an example of proximity-based and role-based access control in accordance with another illustrative embodiment;

FIG. 10 depicts a sequence diagram in accordance with an illustrative embodiment;

FIG. 11 depicts a block diagram of an example processing environment in accordance with an illustrative embodiment;

FIG. 12 depicts a flowchart of an example process for proximity-based data access control in accordance with an illustrative embodiment; and

FIG. 13 depicts a flowchart of an example process for proximity-based data access control in accordance with an illustrative embodiment.

### DETAILED DESCRIPTION

Businesses and other institutions in nearly every industry utilize computer networking and database technologies to store various types of pertinent information. Hospitals store patient data, schools store student data, retailers store customer and product data, and so on. This data often includes sensitive data that is meant to be securely stored such that access to the sensitive data is intended to be limited. For a school, sensitive data may include student education records that are subject to Family Educational Rights and Privacy Act (FERPA) privacy requirements. For a retailer, sensitive data may include proprietary product information or customer payment information that is subject to Payment Card Industry Data Security Standard (PCI DSS) privacy requirements. For a hospital, sensitive data may include patient health information that is subject to Health Insurance Portability and Accountability Act (HIPAA) privacy requirements.

To protect such sensitive data, a number of authentication and authorization techniques have been proposed and implemented. The most common authentication technique is password authentication, which involves asking a user to provide a secret password and verifying that the password input by the user is correct. A more sophisticated authentication technique is biometric authentication, which involves comparing a physical feature of the user, such as a fingerprint or iris, to physical feature data previously provided by the user. Even more elaborate authentication methods include multi-factor authentication techniques, which require a user to provide two or more authentication inputs, such as a password and a code that is sent to something that would be in the user's possession (e.g., a code sent as a text message to the user's phone).

While these and other authentication techniques can be effective for limiting access to sensitive data, they all fail to address the types of information leaks and other problems that can occur due to misidentified data. The misidentified data problem arises when a user, who is authorized to access the sensitive data of others, mistakenly uses sensitive data of the wrong person. For example, sensitive data about one patient may inadvertently be accessed, relied upon, or mentioned to another patient due to mistaking one patient for another, or school administrators may inadvertently access, rely on, or mention sensitive data about another student due to mistaking one student for another. These types of issues present a technical problem of how to limit a user's access to sensitive data such that a user, who may have a legitimate need to access sensitive data of other people from time to time, may only access the sensitive data of a particular other person when the need arises.

In today's service-oriented environment, quick access to customer data is at the center of providing excellent service. Specifically, access to sensitive data is almost always required. The disclosed embodiments provide quick and real-time access to sensitive data based on proximity to a customer's proximity device. A service provider's user device is able to receive customer sensitive data while in a threshold proximity of a customer's proximity device and received sensitive data is filtered based on the service provider's role. The data received allows a service provider to use the data to provide excellent service to their customers. The sensitive data is then automatically deleted from the user device when the user device is no longer in the threshold proximity of the proximity device.

In a hospital or other service industry setting, access to sensitive data in real time and as quickly as possible is very important. In the past, in order for a service provider to gain access to a specific customer's sensitive data, the service provider needed to authenticate in some sort of fashion and then find search for the specific customer's data. This process is time consuming, prone to human error, and causes delays that can preclude efforts to provide immediate service.

The disclosed embodiments address and provide a solution to these technical problem using an approach that introduces proximity-based data access control. Exemplary embodiments disclose a system and corresponding process in which a user device (e.g., laptop, tablet, or smartphone) can receive and retain sensitive data automatically when proximity criteria is met, allowing the device to retrieve the data in real time and as quickly as possible. In exemplary embodiments, the user device can receive and retain sensitive data automatically only when it is within a threshold proximity of a specialized electronic device referred to herein as a proximity device. The proximity device does not store or transmit the sensitive data. Instead, the proximity device enables the user device to retrieve the sensitive data from a remote database system when the user device is within the threshold proximity of the proximity device. The user device is then able to store the sensitive data only while it is within the threshold proximity of the proximity device. If the user device moves outside the threshold proximity, the sensitive data is automatically deleted from the user device.

In exemplary embodiments, the proximity device is not configured to send any sensitive data and is incapable of receiving and storing sensitive data. Instead, the information available from the proximity device does not include sensitive data and cannot be used by itself to access any sensitive data. Instead, the proximity device only provides information that must be combined with information associated with an authorized user of a remote database system in order to access data about the person associated with the proximity device. This prevents a person's sensitive data from being accessible to an unauthorized third party if the proximity device is misplaced or otherwise falls into the possession of someone who does not have a legitimate need to access the person's private information.

In exemplary embodiments, the proximity device is an active device that has an on-board battery and periodically transmits its unique device identifier (UDID). In some such embodiments, the proximity device comprises an active RFID tag or Bluetooth transmitter. In other exemplary embodiments, the proximity device is a passive device or battery-assisted passive device that is activated by, and/or periodically transmits its UDID using energy from specified radio waves emitted from another device. In some embodiments, the proximity device is configured to transmit data using a WPAN. In some embodiments, the proximity device is configured to communicate via a WPAN with a user computing device (also referred to more simply as a user device), such as a laptop, tablet, smartphone, or other portable computing device.

In exemplary embodiments, the user device detects the proximity device when the user device is within a threshold proximity of the proximity device. In such embodiments, the threshold proximity is dependent on the transmit power of the proximity device, along with other factors that affect the range of radio frequency (RF) signals, such as antenna gain, receiver sensitivity, and path loss. In some such embodiments, the transmit power of the proximity device is selected to allow for a threshold proximity that is within a desired range under expected operating conditions (e.g., conditions consistent with a specific path loss model used to select the transmit power).

In exemplary embodiments, when a user device detects a signal that matches an expected type of signal from a proximity device (e.g., a signal within a specified frequency range), the user device processes the signal to determine if the signal includes a valid UDID. In some embodiments, the user device determines if the signal includes a valid UDID by determining if the signal includes a recognized UDID. In some such embodiments, the user device compares data encapsulated in the signal to a list of known UDIDs. In some embodiments, the user device determines if the signal includes a valid UDID using an algorithm, such as a checksum formula, which can verify the legitimacy of the UDID.

In exemplary embodiments, when a user device detects a signal from a proximity device that includes a valid UDID, the user device determines whether the UDID is within a specified group of UDIDs assigned to the user device. For example, in some embodiments, the user device may receive a signal from a proximity device associated with sensitive data that the user device is authorized to access and may receive a signal from another proximity device associated with sensitive data that the user device is not authorized to access. In some such embodiments, when the user device detects a valid UDID, the user device determines whether the UDID is on a list of authorized UDIDs associated with sensitive data that the user device is authorized to access. In some embodiments, when the user device determines that the UDID is associated with sensitive data that the user device is authorized to access, the user device proceeds with requesting the sensitive data. Otherwise, if the user device determines that the UDID is associated with sensitive data that the user device is not authorized to access, the user device ignores the signal.

In exemplary embodiments, after a user device detects a signal from a proximity device that includes a valid UDID, the user device transmits a UDID acknowledgement signal to the proximity device. In some embodiments, the UDID acknowledgement signal is configured to trigger the proximity device to transmit a unique user identifier (UUID) (also referred to herein more simply as a user identifier (UID)). The UUID is an identifier that can be used to query a database or other data storage for sensitive data associated with the proximity device. Thus, in some embodiments, the sensitive data associated with the proximity device is associated with the UUID in a database. In some embodiments, the UDID acknowledgement signal includes a specified command or string that is recognized by the proximity device as a trigger for causing the proximity device to transmit the UUID. In some embodiments, the UDID acknowledgement signal includes a packet with an acknowledgement bit that is set.

In exemplary embodiments, when a user device detects a signal from a proximity device after the user device has transmitted an acknowledgement signal, the user device processes the signal to determine if the signal includes a UUID. In some embodiments, if the user device detects a UUID, the user device extracts the UUID from the signal. The user device then transmits an information request to a remote access control system. In some embodiments, the remote access control system controls access to a database that stores sensitive data.

In exemplary embodiments, the user device communicates with the proximity device using a first type of network and communicates with the remote access control system using a second type of network. In some embodiments, the user device communicates with the proximity device using a WPAN. In some such embodiments, the user device communicates with the remote access control device using a type of network larger than the WPAN, such as a WAN or LAN. In such embodiments, the user device communicates with the proximity device using a WPAN as a proximity restriction imposed on the user device. The limited distance covered by a WPAN helps to restrict the user device's access to the sensitive data associated with a proximity device to those situations in which the user of the user device is in close proximity to the person associated with the proximity device. On the other hand, the larger distances covered by other network types, such as LANs and WANs, allow the database system that stores the sensitive data to be accessed by user devices spread across a large geographical area, thereby obviating the need to store sensitive data in close proximity to a person associated with the sensitive data. Thus, a user device must be in close proximity to a proximity device in order to access associated sensitive data while the proximity device may be located anywhere in a large geographical area.

In exemplary embodiments, the information request includes the UUID received from the proximity device as well as a role-based information control (RBIC) (sometimes also referred to as role-based access control (RBAC)) identifier that is associated with the user device and conveys a role assigned to the user associated with the user device. In some embodiments, the remote access control system uses the UUID to limit the user's access to only information associated with the owner of the proximity device associated with the UUID (i.e., UUID information), and uses the RBIC to limit the user's access to the UUID information by filtering the UUID information based on the user's role. In some such embodiments, the access control system may be configured to allow roles to be created for various job functions with the permissions to access certain types of data being assigned to specific roles.

As a simplified example, an access control system used by a retailer may have a sales role for members of a sales department and may have an accountant role for members of an accounting department. In this example, the access control system may limit the sales role to customer data (e.g., customer preferences, purchase history, etc.) and product data (e.g., pricing and availability information), and may limit the accounting role to accounting data (e.g., payables, payroll, etc.).

As another simplified example, an access control system used by a hospital may have a physician role, an occupational therapist role, and a dietician role for members of those respective professions. In this example, the access control system allows all three of these roles to access patient health information to varying degrees. The physician role may have complete access to a patient's health information, whereas the occupational therapist and dietician roles have only limited access to a patient's health information. For example, the occupational therapist role may be limited to a patient's current condition as needed by the occupational therapist to provide the patient with exercises and therapies. The dietician role may be limited to a patient's diet restrictions, such as allergies, whether the patient is diabetic, etc.

Thus, the access control system assigns users to particular roles, and through those role assignments, users acquire the permissions needed to access only the portions of sensitive data that are necessary to perform their particular job functions. The users are then able to access data only if their role has been granted permission to access the data. In addition, in some embodiments, the access control system allows for configuration of one or more UUID information rules that specify permissions for performing operations on or using the sensitive data according to role assignments. Thus, through role assignments, some users may acquire the permissions needed to perform operations using the sensitive data that are necessary to perform their particular job functions. The users are then able to perform such operations only if their role has been granted permission to access the data. For example, the hospital in the above example may have an Emergency Medical Technician (EMT) role that has permission to transmit UUID information to a third party outside a proximity threshold of a patient's proximity device. In this example, this permission may be granted so that, when the EMT is transporting a patient to an emergency room, the EMT can send the patient information ahead to allow the emergency room to be ready for the incoming patient.

In exemplary embodiments, the access control system detects an information request from a user device. The access control system processes the information request and determines that the information request includes a UUID and an RBIC identifier that identifies a role of the user associated with the user device. In some embodiments, the access control system then generates a database query that will query the database for the UUID. In some embodiments, the access control system generates the database query using a template stored in the access control system local memory. The access control system sends the UUID query to the database.

In exemplary embodiments, if the database responds to the query with an indication that the UUID is not in the database, the access control system then notifies the user device that the UUID was not found. On the other hand, if the database responds to the query with an indication that the UUID is in the database, the access control system then generates another database query that will query the database for information associated with the UUID. In some embodiments, the access control system generates the database query using a template stored in the access control system local memory. The access control system sends the UUID query to the database.

In exemplary embodiments, if the database responds to the query with an indication that the UUID is in the database, but no UUID information is associated with the UUID, the access control system then notifies the user device that the UUID was found, but no UUID information was found. On the other hand, if the database responds to the query with UUID information, the access control system then checks local memory for data filters associated with the user's role as conveyed to the access control system by the RBIC identifier. If the access control system identifies one or more data filters associated with the RBIC identifier, then the access control system applies the data filter(s) to the UUID information. The access control system then transmits the filtered UUID information to the user device.

In exemplary embodiments, when a user device receives filtered UUID information from an access control system, the user device stores the filtered UUID information on a local computer readable storage medium. The user device then also makes the filtered UUID information accessible to the user, for example by providing a display of the UUID information, playing audio from the UUID information, or otherwise making the filtered UUID information accessible to the user.

In exemplary embodiments, while the filtered UUID information is stored in the local computer readable storage medium, the user device monitors the distance to the proximity device associated with the UUID. In some embodiments, the monitoring of the distance by the user device includes the user device detecting that it has been relocated and then determining if a signal from the proximity device can still be received. In some embodiments, the monitoring of the distance by the user device includes the user device sending a particular signal to the proximity device that triggers a response from the proximity device if the user device is still within the proximity threshold. For example, in some embodiments, the user device transmits an Internet Control Message Protocol (ICMP) echo request that triggers an ICMP echo reply from the proximity device if the proximity device is reachable. In such embodiments, the user device determines that it is still within the proximity threshold if a response is received from the proximity device, and otherwise if no response is received, then the user device determines that it is outside the proximity threshold. In some embodiments, the monitoring of the distance by the user device includes the user device monitoring for a signal that is periodically transmitted by the proximity device according to a pattern that is known to the user device. In such embodiments, the user device determines that it is still within the proximity threshold if the periodic signal is received from the proximity device, and otherwise if no periodic signal from the proximity device is received, then the user device determines that it is outside the proximity threshold.

In exemplary embodiments, when the user device determines that its current location exceeds the threshold proximity to the proximity device, the user device automatically deletes the UUID information from the local computer readable storage medium.

In exemplary embodiments, when the user device receives the filtered UUID information, the user device disables screenshot functionality. In such embodiments, when the user device deletes the filtered UUID information, the user device re-enables the screenshot functionality.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

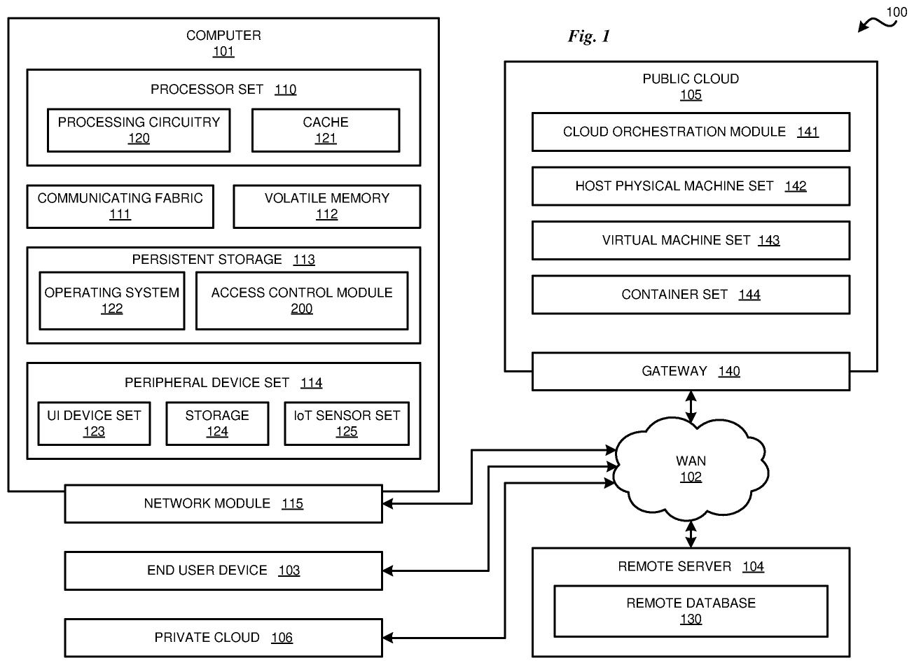

With reference to FIG. 1, this figure depicts a block diagram of a computing environment 100. Computing environment 100 contains an example of an environment for the execution of at least some of the computer code involved in performing the inventive methods, such as an improved access control module 200 that performs proximity-based data access control. In addition to access control module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and access control module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in access control module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in access control module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

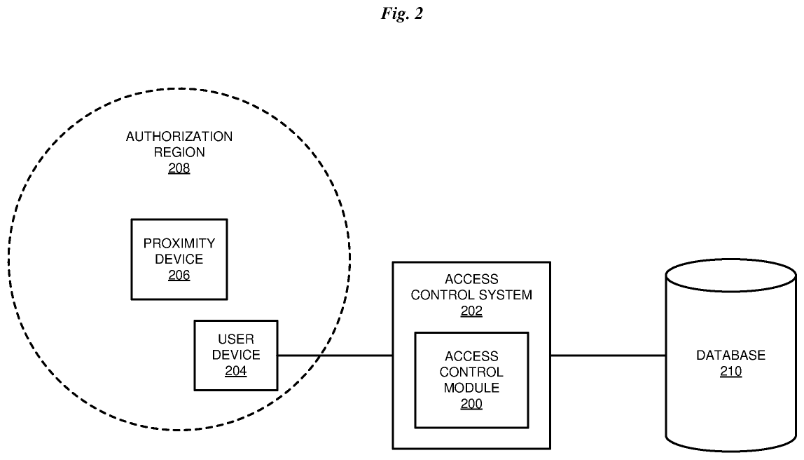

With reference to FIG. 2, this figure depicts a block diagram of an example network architecture that includes an access control module 200 in accordance with an illustrative embodiment. In the illustrated embodiment, an access control system 202 comprises the access control module 200. In an embodiment, the access control system 202 is an example of the computer 101 of FIG. 1.

In the illustrated embodiment, a user device 204 is configured to detect when a proximity device 206 is within a threshold proximity, which is shown as authorization region 208. The proximity device 206 is associated with someone having sensitive data stored in a database 210. The access control module 200 of the access control system 202 limits access to sensitive data in the database 210.

The user device 204 can access and store sensitive data about the person associated with the proximity device 206 while the user device 204 remains within the authorization region 208, which is bound by a threshold proximity of the proximity device. When the user device 204 moves outside the authorization region 208, any sensitive data associated with the proximity device 206 is automatically removed from the user device 204.

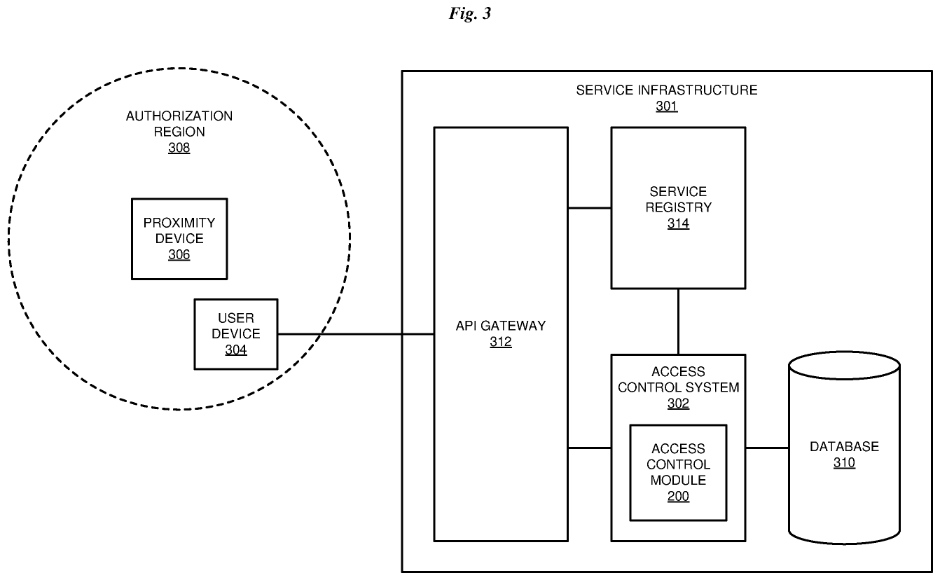

With reference to FIG. 3, this figure depicts a block diagram of an example service infrastructure 301 in accordance with an illustrative embodiment. In the illustrated embodiment, service infrastructure 301 comprises an access control system 302 that comprises the access control module 200. In an embodiment, the access control system 302 is an example of the computer 101 of FIG. 1.

In the illustrated embodiment, the service infrastructure 301 provides services and service instances to user communication terminals, for example user device 304. The user device 304 communicates with service infrastructure 301 via an API gateway 312. In various embodiments, service infrastructure 301 and its associated access control system 302 serve multiple users and multiple tenants. A tenant is a group of users (e.g., a company) who share a common access with specific privileges to the software instance. Service infrastructure 301 ensures that tenant specific data is isolated from other tenants.

In the illustrated embodiment, service infrastructure 301 includes a service registry 314. In some embodiments, the access control system 302 is a virtual machine and the service registry 314 looks up service instances of access control system 302 in response to a service lookup request such as one from API gateway 312 in response to an information request from user device 304.

In some embodiments, service registry 314 maintains information about the status or health of each service instance including performance information associated each of the service instances. In some such embodiments, such information may include various types of performance characteristics of a given service instance (e.g., cache metrics, etc.) and records of updates.

In some embodiments, user communication terminals connect with API gateway 312 via any suitable network or combination of networks such as the Internet, cellular networks, public switched telephone network, etc. and uses any suitable communication protocols such as Wi-Fi, Bluetooth, etc. Service infrastructure 301 may be built on the basis of cloud computing. API gateway 312 provides access to client applications like the access control module 200. API gateway 312 receives service requests issued by client applications and creates service lookup requests based on service requests. As a non-limiting example, in an embodiment, the user device 304 executes a routine to request data from the database 310 via the access control module 200 when the user device 304 enters an authorization region 308 associated with a proximity device 306. For instance, in some embodiments, the user accesses the access control module 200 directly using a command line or GUI. Also, in some embodiments, the user accesses the access control module 200 indirectly through the use of an application that interacts with the access control module 200 via the API gateway 312.

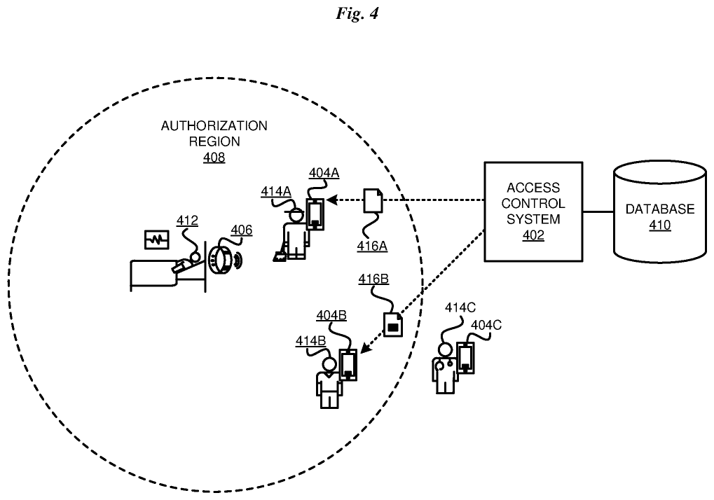

FIGS. 4-9 depict embodiments using example scenarios involving the medical industry to further illustrate example implementations of the illustrative embodiments and to aid in the understanding of the mechanisms of the illustrative embodiments. These examples are intended to be non-limiting and are not exhaustive of the various industries in which the mechanisms of the illustrative embodiments may be implemented. It will be apparent to those of ordinary skill in the art in view of the present description that there are many other alternative implementations for the various described elements that may be utilized in addition to, or in replacement of, the examples provided herein without departing from the spirit and scope of the present invention.

With reference to FIG. 4, this figure depicts a block diagram of an example of proximity-based and role-based access control in accordance with an illustrative embodiment. In the illustrated embodiment, a patient 412 in a medical facility has a proximity device 406. Sensitive data about the patient 412 is stored in a database 410. An access control system 402 controls access to data stored in the database 410.

An authorization region 408 is defined by a threshold proximity from the proximity device 406. The authorization region 408 is a region within which a signal emitted by the proximity device 406 can be received by a user device. In FIG. 4, a first user 414A and a second user 414B are both within the authorization region 408, while a third user 414C is outside the authorization region 408. As a result, the first and second user devices 404A and 404B are able to receive the signal emitted by the proximity device 406, but the user device 404C is outside the authorization region 408 and not able to receive the signal emitted by the proximity device 406.

The proximity device 406 is assigned a UDID. In some embodiments, the UDID is permanently assigned to the UDID and is stored in read only memory (ROM) of the proximity device 406. The proximity device 406 is configured to wirelessly transmit the UDID. In some embodiments, the proximity device 406 periodically transmits the UDID. In some embodiments, the proximity device 406 transmits the UDID in response to being triggered by a user. For example, the proximity device 406 may include a pairing function that a user can initiate that causes the proximity device 406 to transmit the UDID. In some embodiments, the proximity device 406 transmits the UDID in response to a signal received from another device, such as a UDID query.

In some embodiments, the proximity device 406 is an active device that has an on-board battery. In some such embodiments, the proximity device 406 comprises an active RFID tag or Bluetooth transmitter. In some embodiments, the proximity device 406 is a passive device or battery-assisted passive device that is activated by specified radio waves emitted from another device. In some embodiments, the proximity device 406 is configured to transmit data using a WPAN. In some embodiments, the proximity device 406 is configured to communicate via a WPAN with a user device, such as the user devices 404A and 404B.

In the illustrated embodiment, the user devices 404A and 404B detect the proximity device 406 since the user devices 404A and 404B are within the threshold proximity of the proximity device 406. In some embodiments, the threshold proximity is dependent on the transmit power of the proximity device 406, along with other factors that affect the range of radio frequency (RF) signals, such as antenna gain, receiver sensitivity, and path loss. Thus, while the authorization region 408 is shown as being circular, in actual implementations the shape of the authorization region 408, and therefore the distance of the threshold proximity, may vary depending on environmental factors that affect the propagation of RF signals from the proximity device 406, such as those that cause path loss. In some such embodiments, the transmit power of the proximity device 406 is selected to allow for a threshold proximity that is within a desired range under expected operating conditions (e.g., conditions consistent with a specific path loss model used to select the transmit power).

In some embodiments, user devices 404A and 404B each detect a signal from the proximity device 406 that includes a UUID. The user devices 404A and 404B then transmit an information request to the access control system 402. In the illustrated embodiment, the access control system 402 controls access to a database 410 that stores sensitive data. In some embodiments, the information request includes the UUID received from the proximity device 406 as well as role-based information control (RBIC) (sometimes also referred to as role-based access control (RBAC)) identifiers that are associated with respective user devices 404A and 404B. In some embodiments, the access control system 402 uses the UUID to limit the requesting user's access to only information associated with the UUID, which is limited to sensitive data associated with the patient 412, who, in the illustrated example, is the owner or is otherwise associated with the proximity device 406. The access control system 402 uses the RBIC to limit the requesting user's access to the UUID information by filtering the UUID information based on the user's role. For example, in the illustrated embodiment, the first user 414A is an example of a user who is associated with an RBIC identifier that is not authorized to receive any portion of the UUID information associated with the patient 412 as indicated by the empty document 416A. The second user 414B is an example of a user who is who is associated with an RBIC identifier that is authorized to receive some portion of the UUID information associated with the patient 412 as indicated by the populated document 416B.

In some embodiments, the user devices 404A and 404B communicate with the proximity device 406 using a first type of network and communicate with the access control system 402 using a second type of network. In some embodiments, the user devices 404A and 404B communicate with the proximity device 406 using a WPAN. In some such embodiments, the user devices 404A and 404B communicate with the access control system 402 using a type of network is larger than the WPAN, such as a WAN or LAN. In such embodiments, the user devices 404A and 404B communicate with the proximity device 406 using a WPAN as a proximity restriction imposed on the user devices 404A and 404B.

In some embodiments, the access control system 402 detects information requests from user devices, such as user devices 404A and 404B in the illustrated embodiment. The access control system 402 processes the information requests and determines whether the information requests include a UUID and an RBIC. If so, then the access control system 402 extracts the UUID and RBIC from each information request. Then, for each received information request, the access control system 402 generates a database query that includes the UUID (i.e., a UUID query) and will determine whether any data associated with the UUID is stored in the database 410. In some embodiments, the access control system 402 generates the database query using a template stored in the access control system 402 local memory.

The access control system 402 issues the UUID query to the database 410 and receives a response from the database 410 indicating either that there is or is not data associated with the UUID present in the database 410. The access control system 402 also checks local memory for any data filters that are associated with the RBIC. If so, this means that the user associated with the RBIC is not authorized to receive certain types of sensitive data stored in the database 410 as defined by the data filter(s).

In some embodiments, the database 410 returns all of the data associated with the UUID along with the response to the UUID query. In some such embodiments, the access control system 402 then applies any data filter(s) associated with the RBIC to the received data. In some embodiments, the database 410 returns only an indication of whether there is data associated with the UUID. In some such embodiments, the access control system 402 then generates one or more queries for data associated with the UUID that limit the data being requested in the query according to one or more data filters associated with the RBIC. In some embodiments, the database 410 returns only an indication of whether there is data associated with the UUID. In some such embodiments, the access control system 402 then generates a query for all of the data associated with the UUID, and then applies any data filter(s) associated with the RBIC to the received data.

In the illustrated embodiment, when the user device 404B receives the filtered UUID information 416B from the access control system 402, the user device 404B stores the filtered UUID information 416B on a local computer readable storage medium. The user device 404B then also makes the filtered UUID information 416B accessible to the second user 414B, for example by providing a display of the UUID information 416B, playing audio from the UUID information 416B, or otherwise making the filtered UUID information 416B accessible to the second user 414B.

In some embodiments, while the filtered UUID information 416B is stored in the local computer readable storage medium, the user device 404B monitors the distance to the proximity device 406 associated with the UUID. In some embodiments, the monitoring of the distance by the user device 404B includes the user device 404B detecting that it has been relocated and then determining if a signal from the proximity device 406 can still be received. In some embodiments, the monitoring of the distance by the user device 404B includes the user device 404B sending a particular signal to the proximity device 406 that triggers a response from the proximity device 406 if the user device 404B is still within the proximity threshold. For example, in some embodiments, the user device 404B transmits an Internet Control Message Protocol (ICMP) echo request that triggers an ICMP echo reply from the proximity device 406 if the proximity device 406 is reachable. In such embodiments, the user device 404B determines that it is still within the proximity threshold if a response is received from the proximity device 406, and otherwise if no response is received, then the user device 404B determines that it is outside the proximity threshold. In some embodiments, the monitoring of the distance by the user device 404B includes the user device 404B monitoring for a signal that is periodically transmitted by the proximity device 406 according to a pattern that is known to the user device 404B. In such embodiments, the user device 404B determines that it is still within the proximity threshold if the periodic signal is received from the proximity device 406, and otherwise if no periodic signal from the proximity device 406 is received, then the user device 404B determines that it is outside the proximity threshold.

In some embodiments, when the user device 404B determines that its current location exceeds the threshold proximity to the proximity device 406, the user device 404B automatically deletes the UUID information 416B from the local computer readable storage medium.

In some embodiments, when the user device 404B receives the filtered UUID information 416B, the user device 404B disables its screenshot functionality. In such embodiments, when the user device 404B deletes the filtered UUID information 416B, the user device 404B re-enables its screenshot functionality.

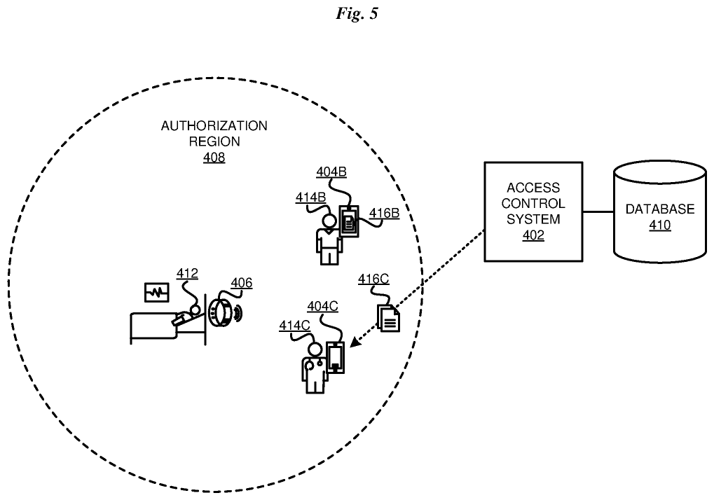

With reference to FIG. 5, this figure depicts a block diagram of an example of proximity-based and role-based access control in accordance with an illustrative embodiment. The embodiment shown in FIG. 5 follows the example scenario shown in FIG. 4, where in FIG. 5 the first user 414A has left the area completely, the second user 414B has moved but is still within the authorization region 408, and the third user 414C has moved from outside the authorization region 408 to inside the authorization region 408.

Since the second user device 404B remains within the authorization region 408, the second user device 404B can still receive signals from the proximity device 406. However, the second user device 404B recognizes that it has already received data associated with the UUID of the patient 412 and therefore does not make repeated requests for the UUID information. Instead, since the second user device 404B still receives signals from the proximity device 406, the second user device 404B retains the UUID information 416B in its local memory.

When the third user 414C moves within the authorization region 408, the third user device 404C begins receiving signals from the proximity device 406. The user device 404C then detects that the signal from the proximity device 406 includes a UUID, transmits a UUID information request (including the RBIC associated with the third user 414C) to the access control system 402, and receives UUID information 416C in response to the request.

In the illustrated embodiment, the UUID information 416C is shown as multiple documents, compared to the UUID information 416B that is shown as a single document, which is meant to illustrate an example where two users are authorized to receive different amounts of sensitive data for the same UUID. For example, the second user 414B may be assigned an occupational therapist role, whereas the third user 414C may be assigned a physician role. Therefore, the second user 414B has only limited access to the health information for the patient 412, for example limited to a patient's current condition as needed by an occupational therapist to provide the patient with exercises and therapies. The third user 414C, on the other hand, has complete access to the health information for the patient 412.

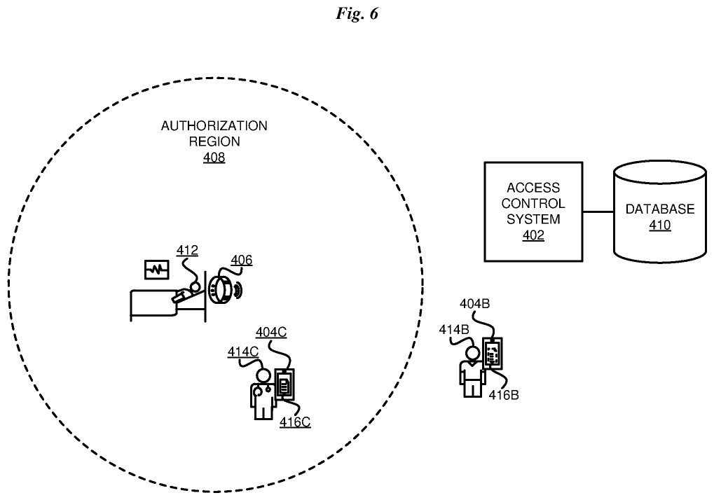

With reference to FIG. 6, this figure depicts a block diagram of an example of proximity-based and role-based access control in accordance with another illustrative embodiment. The embodiment shown in FIG. 6 follows the example scenario shown in FIGS. 4 and 5, where in FIG. 6 the second user 414B has left the authorization region 408, and the third user 414C has moved but is still within the authorization region 408, and the third user 414C has moved from outside the authorization region 408 to inside the authorization region 408.

Since the third user device 404C remains within the authorization region 408, the third user device 404C can still receive signals from the proximity device 406. However, the third user device 404C recognizes that it has already received data associated with the UUID of the patient 412 and therefore does not make repeated requests for the UUID information. Instead, since the third user device 404C still receives signals from the proximity device 406, the third user device 404C retains the UUID information 416C in its local memory.

Since the second user device 404B is no longer within the authorization region 408, the second user device 404B can no longer receive signals from the proximity device 406. As a result, the second user device 404B automatically deletes the UUID information associated with the patient 412 from its local memory (as indicated by second user UUID information 416B being illustrated using broken lines).

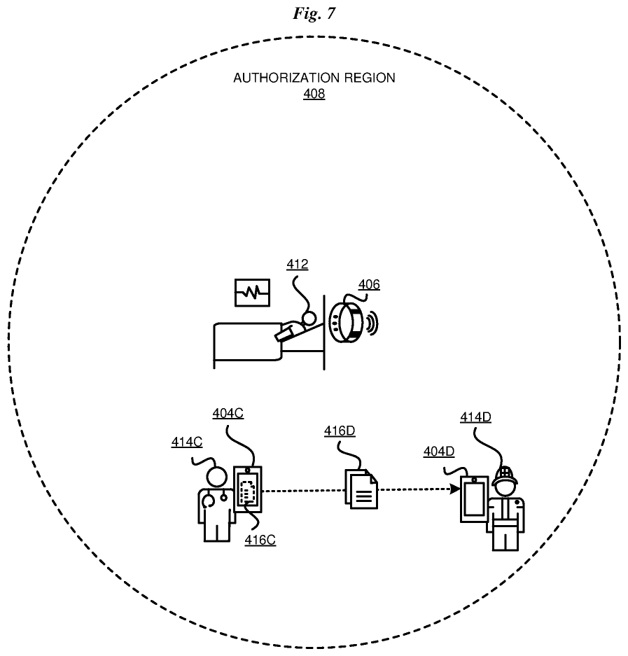

With reference to FIG. 7, this figure depicts a block diagram of an example of proximity-based and role-based access control in accordance with another illustrative embodiment. The embodiment shown in FIG. 7 follows the example scenario shown in FIGS. 4-6, where in FIG. 7 the second user 414B has left the area completely, the third user 414C has moved but is still within the authorization region 408, and a fourth user 414D has arrived within the authorization region 408.

In the illustrated scenario, the fourth user 414D is an EMT that has arrived to transport the patient 412 to a different medical facility and therefore needs to receive the health information for the patient 412. In some embodiments, some users may have an RBIC identifier that allows the users to perform operations using the sensitive data that are necessary to perform their particular job functions. For example, in the illustrated embodiment, the third user 414C has an RBIC identifier that allows the third user 414C to transmit a copy of the UUID information to other users that are within the authorization region 408. As illustrated, the third user device 404C is therefore able to transmit a copy of the UUID information 416C to the fourth user device 404D, where the transmitted copy is designated UUID information 416D and may include only some or all of the UUID information 416C. Also, in some embodiments, once the third user device 404C has transmitted the UUID information 416D to another user, the UUID information 416C is deleted from the user device 404C either automatically or at the request of the third user 414C due to control of the patient 412 being transferred to the fourth user 414D.

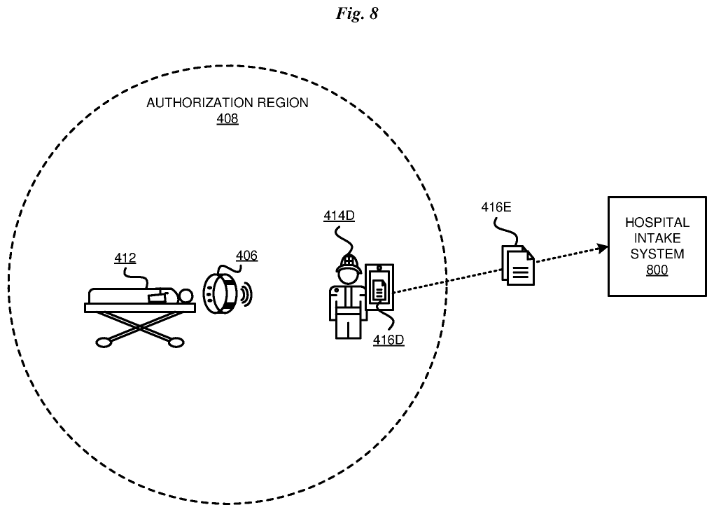

With reference to FIG. 8, this figure depicts a block diagram of an example of proximity-based and role-based access control in accordance with another illustrative embodiment. The embodiment shown in FIG. 8 follows the example scenario shown in FIGS. 4-7, where in FIG. 8 the patient 412 is being transported to a different medical facility and the fourth user 414D is transporting the patient 412 and remains in the authorization region 408 since both the authorization region 408 and the fourth user 414D are moving with the patient 412.

In the illustrated scenario, the fourth user 414D is transporting the patient 412 to a medical facility that has a hospital intake system 800 that can receive patient records electronically. The fourth user 414D has an RBIC identifier that allows the fourth user 414D to transmit UUID information to third parties that are outside of the 408, including the hospital intake system 800. Therefore, the fourth user 414D is able to transmit a copy of the UUID information 416D to the hospital intake system 800, where the transmitted copy is designated UUID information 416E and may include only some or all of the UUID information 416D.

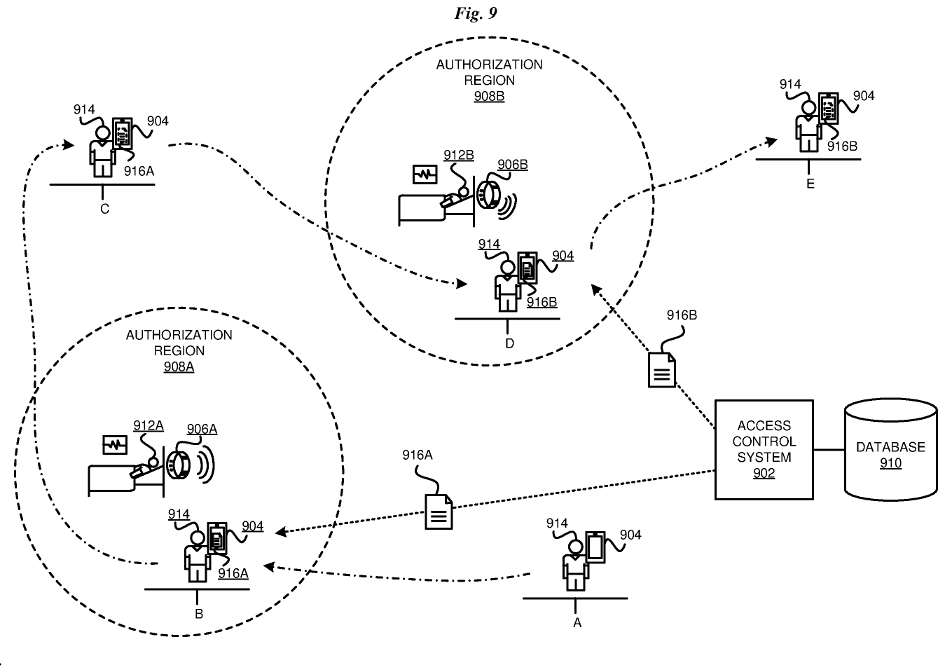

With reference to FIG. 9, this figure depicts a block diagram of an example of proximity-based and role-based access control in accordance with another illustrative embodiment. The embodiment shown in FIG. 9 shows an example scenario in which a user 914 moves through the illustrated area along the dash-dotted line from time A to time E, where the illustrated area includes multiple authorization regions 908A and 908B.

At time A, the user 914 is outside the authorization regions 908A and 908B. As a result, the user device 904 is not able to receive the signals emitted by the disc-type proximity device 906A or by the pendant-type proximity device 906B.

At time B, the user 914 has moved from outside the authorization region 908A to inside the authorization region 908A. When the user 914 moves within the authorization region 908A, the user device 904 begins receiving signals from the disc-type proximity device 906A. The user device 904 then detects that the signal from the disc-type proximity device 906A includes a UUID, and then transmits a UUID information request (including the RBIC associated with the user 914) to the access control system 902. The access control system 902 retrieves data associated with the UUID from the database 910, filters the UUID information based on the RBIC associated with the user 914, and transmits the filtered UUID information 916A as a response to the request from the user device 904. The user device 904 receives the UUID information 916A and stores the UUID information 916A in local memory.

At time C, the user 914 has moved from inside the authorization region 908A to outside the authorization region 908A. Since the second user device 904 is no longer within the authorization region 908A, the user device 904 can no longer receive signals from the disc-type proximity device 906A. As a result, the user device 904 automatically deletes the UUID information 916A associated with the first patient 912A from its local memory (as indicated by UUID information 916A being illustrated using broken lines).

At time D, the user 914 has moved from outside the authorization region 908B to inside the authorization region 908B. When the user 914 moves within the authorization region 908A, the user device 904 begins receiving signals from the pendant-type proximity device 906B. The user device 904 then detects that the signal from the pendant-type proximity device 906B includes a UUID, and then transmits a UUID information request (including the RBIC associated with the user 914) to the access control system 902. The access control system 902 retrieves data associated with the UUID from the database 910, filters the UUID information based on the RBIC associated with the user 914, and transmits the filtered UUID information 916B as a response to the request from the user device 904. The user device 904 receives the UUID information 916B and stores the UUID information 916B in local memory.

At time E, the user 914 has moved from inside the authorization region 908B to outside the authorization region 908B. Since the second user device 904 is no longer within the authorization region 908B, the user device 904 can no longer receive signals from the pendant-type proximity device 906B. As a result, the user device 904 automatically deletes the UUID information 916B associated with the second patient 912B from its local memory (as indicated by UUID information 916B being illustrated using broken lines).

Thus, as a user such as user 914 moves throughout an area such as is shown in FIG. 9, the information that the user 914 needs when coming in close proximity to a patient is automatically retrieved and made available to the user 914 on the user device 904. When the user 914 leaves one patient and moves within close proximity to another, the sensitive data of the last patient is automatically removed from the user device 904 and the sensitive data for the next patient is automatically retrieved and made available to the user 914 on the user device 904.

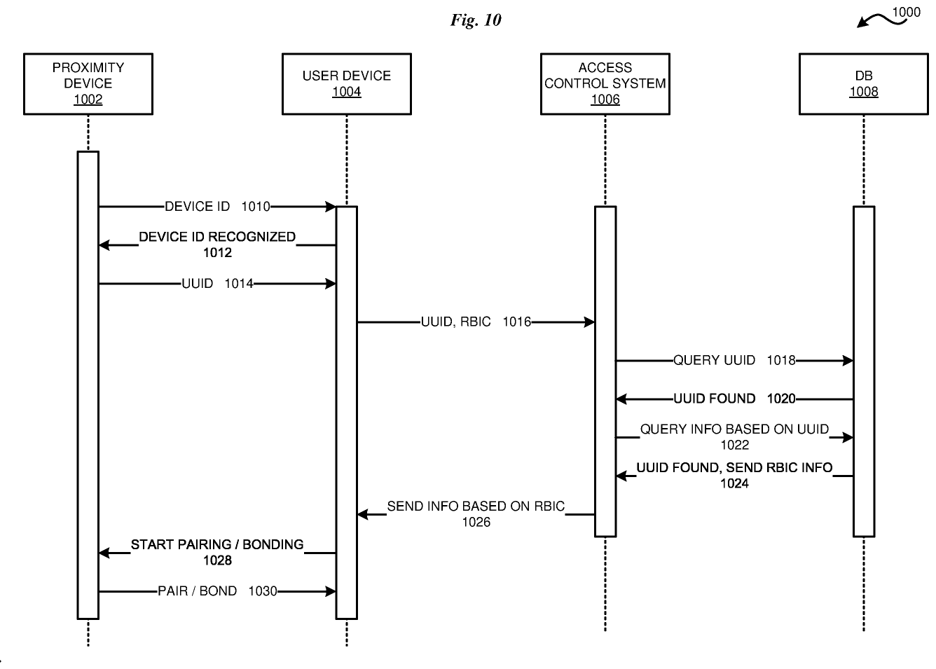

With reference to FIG. 10, this figure depicts a sequence diagram 1000 in accordance with an illustrative embodiment. In an embodiment, the illustrated sequence of signals is used to pair and bond a proximity device 1002 with a user device 1004. In an embodiment, the proximity device 1002 is an example of a proximity device 406 of FIGS. 4-8 or disc-type proximity device 906A or pendant-type proximity device 906B of FIG. 9, and the user device 1004 is an example of the user devices 404A-404E of FIGS. 4-8 or user device 904 of FIG. 9.

In the illustrated embodiment, a device ID 1010 identifies the proximity device 1002 that may be paired and bonded with the user device 1004. If the user device 1004 recognizes the device ID as part of its assigned group, then it sends an acknowledgement 1012 to the proximity device 1002. If the device ID is not recognized, then the user device 1004 ignores the proximity device 1002.

If the device ID is recognized an acknowledgement 1012 is sent to the proximity device proximity device 1002, the proximity device 1002 sends its UUID 1014. The user device 1004 then sends the UUID and the RBIC information 1016 assigned to the holder of the user device 1004 to the backend access control system 1006.

The backend access control system 1006 sends a series of queries to the database 1008. The first one is the UUID query 1018 to determine if the UUID has any associated data stored in the database 1008. If so, the database 1008 responds with a UUID found signal 1020. If the UUID is associated with data in the database 1008 and refers to a real person, the access control system 1006 issues a query based on the UUID 1022 to the database 1008.

The access control system 1006 receives the UUID information 1024 from the database 1008. The access control system 1006 filters the information based on the RBIC and only sends information 1026 that is allowed to be received by the person's RBIC identifier.

Once information 1026 is received by the user device 1004, the user device 1004 sends a pairing/bonding signal 1028 to the proximity device 1002. In response, the proximity device 1002 sends a pair/bond signal 1030 to complete the pairing/bonding process.

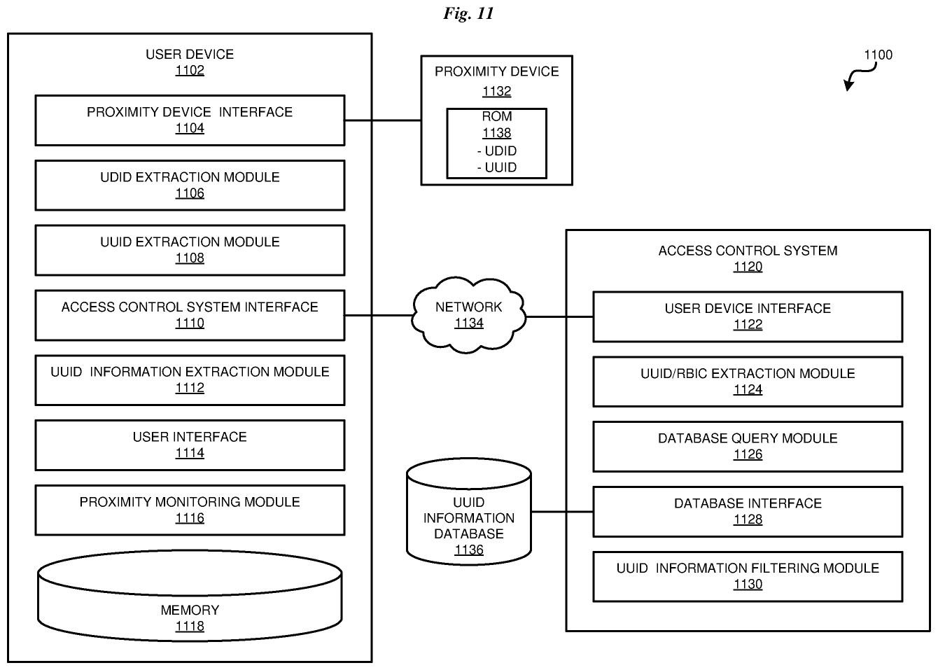

With reference to FIG. 11, this figure depicts a block diagram of an example processing environment 1100 in accordance with an illustrative embodiment. In an embodiment, the user device 1102 is an example of the user devices 404A-404E of FIGS. 4-8 or user device 904 of FIG. 9 or user device 1004 of FIG. 10, and the access control system 1120 is an example of the access control system 402 of FIGS. 4-6 or the access control system 902 of FIG. 9.

In the illustrated embodiment, the user device 1102 includes a proximity device interface 1104, a UDID extraction module 1106, a UUID extraction module 1108, an access control system interface 1110, a UUID information extraction module 1112, a user interface 1114, a proximity monitoring module 1116, and a memory 1118. The access control system 1120 is in communication with the user device 1102 via a network 1134. The access control system 1120 includes a user device interface 1122, a UUID/RBIC extraction module 1124, a database query module 1126, a database interface 1128, and a UUID information filtering module 1130. The access control system 1120 controls access to data stored in a UUID information database 1136. In alternative embodiments, the user device 1102 and/or access control system 1120 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

The proximity device 1132 is assigned a UDID. In some embodiments, the UDID is permanently assigned to the UDID and is stored in ROM 1138 of the proximity device 1132. The proximity device 1132 is configured to wirelessly transmit the UDID. In some embodiments, the proximity device 1132 periodically transmits the UDID. In some embodiments, the proximity device 1132 transmits the UDID in response to being triggered by a user. For example, the proximity device 1132 may include a pairing function that a user can initiate that causes the proximity device 1132 to transmit the UDID. In some embodiments, the proximity device 1132 transmits the UDID in response to a signal received from another device, such as a UDID query.

In the illustrated embodiment, proximity device interface 1104 detects the proximity device 1132 when the user device 1102 is within a threshold proximity of the proximity device 1132. In some embodiments, the threshold proximity is dependent on the transmit power of the proximity device 1132, along with other factors that affect the range of radio frequency (RF) signals, such as antenna gain, receiver sensitivity, and path loss.

In exemplary embodiments, when a proximity device interface 1104 detects a signal that matches an expected type of signal from a proximity device (e.g., a signal within a specified frequency range), the proximity device interface 1104 forwards the signal to the UDID extraction module 1106. The UDID extraction module 1106 processes the signal to determine if the signal includes a valid UDID. In some embodiments, the UDID extraction module 1106 determines if the signal includes a valid UDID by determining if the signal includes a recognized UDID. In some such embodiments, the UDID extraction module 1106 compares data encapsulated in the signal to a list of known UDIDs. In some embodiments, the UDID extraction module 1106 determines if the signal includes a valid UDID using an algorithm, such as a checksum formula, which can verify the legitimacy of the UDID.

In exemplary embodiments, when a UDID extraction module 1106 determines that the signal from the proximity device 1132 includes a valid UDID, the UDID extraction module 1106 determines whether the UDID is within a specified group of UDIDs assigned to the user device 1102. In some embodiments, when the UDID extraction module 1106 determines that the UDID is associated with sensitive data that the user device 1102 is authorized to access, the notifies the proximity device interface 1104.

In some embodiments, when the proximity device interface 1104 receives a notification of a valid UDID from the UDID extraction module 1106, the proximity device interface 1104 transmits a UDID acknowledgement signal to the proximity device 1132. In some embodiments, the UDID acknowledgement signal is configured to trigger the proximity device 1132 to transmit a unique user identifier (UUID) (also referred to herein more simply as a user identifier (UID)). The UUID is an identifier that can be used to query the database 1136 for sensitive data associated with the proximity device 1132. Thus, in some embodiments, the sensitive data associated with the proximity device 1132 is associated with the UUID in the database 1136. In some embodiments, the UDID acknowledgement signal includes a specified command or string that is recognized by the proximity device 1132 as a trigger for causing the proximity device 1132 to transmit the UUID. In some embodiments, the UDID acknowledgement signal includes a packet with an acknowledgement bit that is set.

In exemplary embodiments, when the proximity device interface 1104 detects a signal from the proximity device 1132 after the proximity device interface 1104 has transmitted an acknowledgement signal, the proximity device interface 1104 forwards the signal to the UUID extraction module 1108. The UUID extraction module 1108 processes the signal to determine if the signal includes a UUID. In some embodiments, if the UUID extraction module 1108 detects a UUID, the UUID extraction module 1108 extracts the UUID from the signal. The UUID extraction module 1108 then provides the UUID to the access control system interface 1110.

In some embodiments, when the access control system interface 1110 receives a UUID from the UUID extraction module 1108, the access control system interface 1110 transmits an information request to the access control system 1120 via the network 1134. In the illustrated embodiment, the access control system 1120 controls access to the database 1136 that stores sensitive data. In some embodiments, the information request includes the UUID received from the proximity device 1132 as well as a role-based information control (RBIC) (sometimes also referred to as role-based access control (RBAC)) identifier that is associated with the user device 1102. In some embodiments, the access control system 1120 uses the UUID to limit the requesting user's access to only information associated with the UUID, which is limited to sensitive data associated with the proximity device 1132. The access control system 1120 uses the RBIC to limit the requesting user's access to the UUID information by filtering the UUID information based on the user's role.

In some embodiments, the user device interface 1122 of the access control system 1120 detects the information request from the user device 1102. The user device interface 1122 forwards data from the information request to the UUID/RBIC extraction module 1124. The UUID/RBIC extraction module 1124 processes the information request and determines whether the information request includes a UUID and an RBIC. If so, then the UUID/RBIC extraction module 1124 extracts the UUID and RBIC from the information request. Then the UUID/RBIC extraction module 1124 provides the UUID to the database query module 1126 and provides the RBIC to the UUID information filtering module 1130.

When the database query module 1126 receives a UUID from the UUID/RBIC extraction module 1124, the database query module 1126 generates a database query that includes the UUID (i.e., a UUID query) and will determine whether any data associated with the UUID is stored in the database 1136. In some embodiments, the database query module 1126 generates the database query using a predefined query template. The database query module 1126 then provides the database query to the database interface 1128. Meanwhile, when the 1130 receives an RBIC from the UUID/RBIC extraction module 1124, the UUID information filtering module 1130 determines whether any data filters are associated with the RBIC.

When the database interface 1128 receives a database query from the database query module 1126, the database interface 1128 issues the query to the database 1136 and receives a response from the database 1136 indicating either that there is or is not data associated with the UUID present in the database 1136.

In some embodiments, the database 1136 returns all of the data associated with the UUID along with the response to the UUID query. In some such embodiments, the access control system 1120 then applies any data filter(s) associated with the RBIC to the received data. In some embodiments, the database 1136 returns only an indication of whether there is data associated with the UUID. In some such embodiments, the database query module 1126 then generates one or more queries for data associated with the UUID that limit the data being requested in the query according to one or more data filters associated with the RBIC. In some embodiments, the database 1136 returns only an indication of whether there is data associated with the UUID. In some such embodiments, the database query module 1126 then generates a query for all of the data associated with the UUID, and then applies any data filter(s) associated with the RBIC to the received data.

The user device interface 1122 transmits the filtered UUID information to the user device 1102. The access control system interface 1110 receives the filtered UUID information signal from the access control system 1120 and provides the signal to the UUID information extraction module 1112. The UUID information extraction module 1112 extracts the filtered UUID information and stores the filtered UUID information in the memory 1118. The user device 1102 then also makes the filtered UUID information accessible to the user via the user interface 1114, for example by providing a visual display of the UUID information, playing audio from the UUID information, or otherwise making the filtered UUID information accessible to the user.

In some embodiments, when the UUID information extraction module 1112 stores the filtered UUID information in the memory 1118, the UUID information extraction module 1112 also triggers the proximity monitoring module 1116 to begin monitoring the distance from the user device 1102 to the proximity device 1132 associated with the UUID. In some embodiments, the monitoring of the distance by the proximity monitoring module 1116 includes the UDID extraction module 1106 detecting that it has been relocated and then determining if a signal from the proximity device 1132 can still be received. In some embodiments, the monitoring of the distance by the proximity monitoring module 1116 includes the proximity monitoring module 1116 sending a particular signal to the proximity device 1132 that triggers a response from the proximity device 1132 if the user device 1102 is still within the proximity threshold. For example, in some embodiments, the proximity monitoring module 1116 transmits an Internet Control Message Protocol (ICMP) echo request that triggers an ICMP echo reply from the proximity device 1132 if the proximity device 1132 is reachable. In such embodiments, the proximity monitoring module 1116 determines that the user device 1102 is still within the proximity threshold if a response is received from the proximity device 1132, and otherwise if no response is received, then the proximity monitoring module 1116 determines that the user device 1102 is outside the proximity threshold. In some embodiments, the monitoring of the distance by the proximity monitoring module 1116 includes the proximity monitoring module 1116 monitoring for a signal that is periodically transmitted by the proximity device 1132 according to a pattern that is known to the proximity monitoring module 1116. In such embodiments, the proximity monitoring module 1116 determines that the user device 1102 is still within the proximity threshold if the periodic signal is received from the proximity device 1132, and otherwise if no periodic signal from the proximity device 1132 is received, then the proximity monitoring module 1116 determines that the user device 1102 is outside the proximity threshold.

In some embodiments, when the proximity monitoring module 1116 determines that the current location of the user device 1102 exceeds the threshold proximity to the proximity device 1132, the proximity monitoring module 1116 automatically deletes the UUID information from the memory 1118.

In some embodiments, when the access control system interface 1110 receives the filtered UUID information, the access control system interface 1110 notifies the user interface 1114. When the user interface 1114 receives notification that filtered UUID information has been received, the user interface 1114 disables screenshot functionality. In such embodiments, when the proximity monitoring module 1116 deletes the filtered UUID information, the proximity monitoring module 1116 notifies the user interface 1114 that the filtered UUID information has been deleted. When the user interface 1114 receives notification that filtered UUID information has been deleted, the user interface 1114 re-enables screenshot functionality.

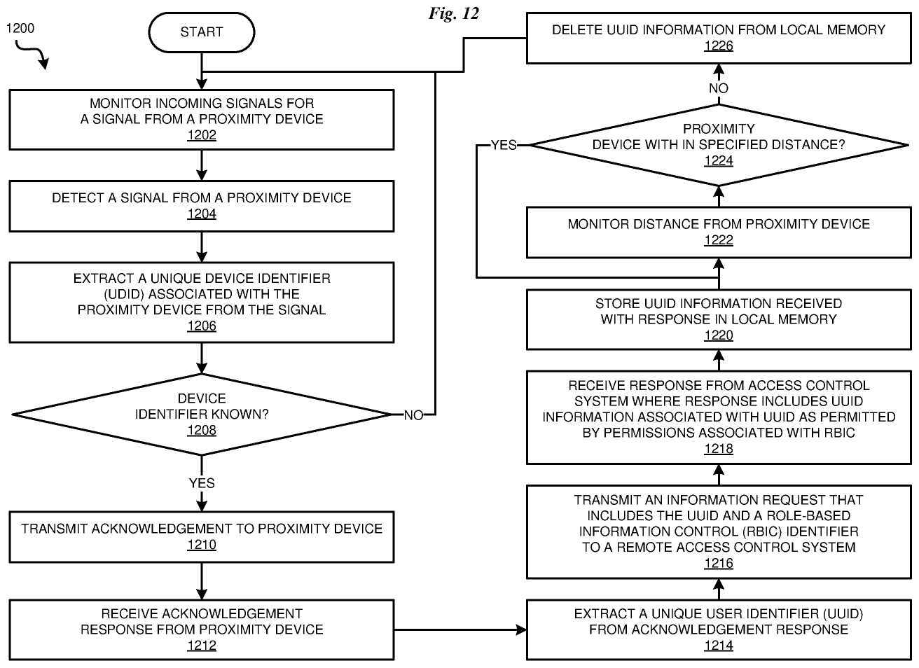

With reference to FIG. 12, this figure depicts a flowchart of an example process 1200 for proximity-based data access control in accordance with an illustrative embodiment. In a particular embodiment, the user devices 404A-404E of FIGS. 4-8 or user device 904 of FIG. 9 or user device 1004 of FIG. 10 or user device 1102 of FIG. 11 carries out the process 1200 as described above.

At block 1202, the process monitors incoming signals for a signal from a proximity device. Next, at block 1204, the process detects a signal from a proximity device. Next, at block 1206, the process extracts a unique device identifier (UDID) associated with the proximity device from the signal. Next, at block 1208, the process determines whether the UDID is known. If the UDID is known, then the process continues to block 1210. Otherwise, the process returns to block 1202.

At block 1210, the process transmits an acknowledgement to the proximity device. Next, at block 1212, the process receives an acknowledgement response from the proximity device. Next, at block 1214, the process extracts a unique user identifier (UUID) from the acknowledgement response. Next, at block 1216, the process transmits an information request that includes the UUID and a role-based information control (RBIC) identifier to a remote access control system. Next, at block 1218, the process receives a response from the access control system where the response includes UUID information associated with the UUID as permitted by permissions associated with the RBIC. Next, at block 1220, the process stores the UUID information received with the response in local memory. Next, at block 1222, the process monitors the distance from the proximity device. At block 1224, the process determines whether the proximity device is still within the specified distance. If so, then the process returns to block 1222 and continues to monitor the distance from the proximity device. Otherwise, the process continues to block 1226.

At block 1226, the process deletes the UUID information from local memory. The process then returns to block 1202.

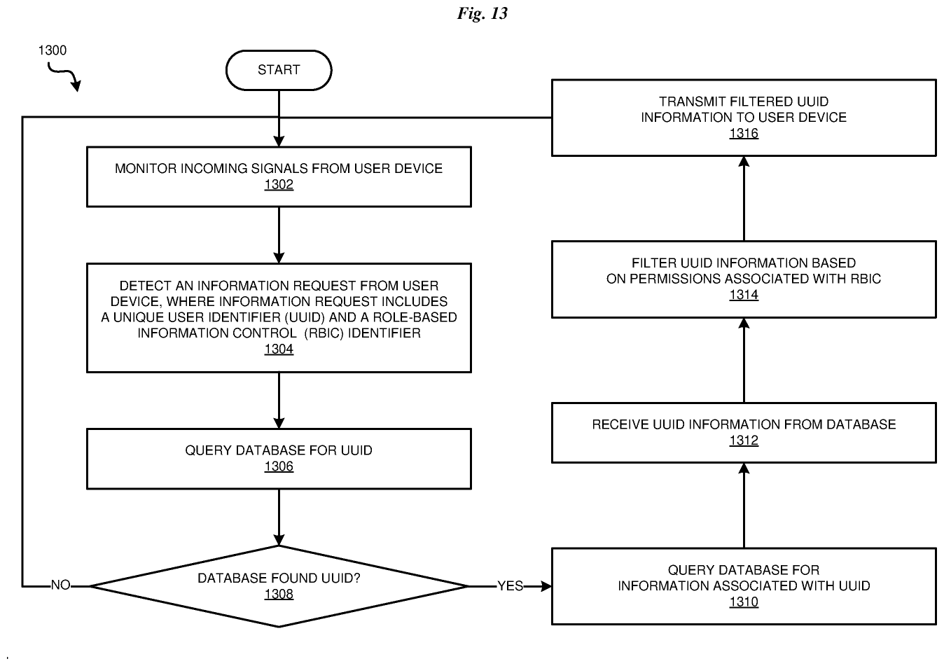

With reference to FIG. 13, this figure depicts a flowchart of an example process 1300 for proximity-based data access control in accordance with an illustrative embodiment. In a particular embodiment, the access control system 402 of FIGS. 4-6 or the access control system 902 of FIG. 9 or the access control system 1120 of FIG. 11 carries out the process 1300 as described above.

At block 1302, the process monitors incoming signals for a signal from a user device. Next, at block 1304, the process detects an information request from a user device, where the information request includes a unique user identifier (UUID) and a role-based information control (RBIC) identifier. Next, at block 1306, the process queries a database for the UUID. Next, at block 1308, the process determines whether the UUID is in the database. If the UUID is in the database, the process continues to block 1310. Otherwise, the process returns to block 1302.

At block 1310, the process queries the database for information associated with the UUID. Next, at block 1312, the process receives UUID information from the database. Next, at block 1314, the process filters the UUID information based on permissions associated with the RBIC. Next, at block 1316, the process transmits the filtered UUID information to the user device. The process then returns to block 1302.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining that a current location is within a threshold proximity to a proximity device;
extracting a unique user identifier (UUID) from data received from the proximity device via a first type of network;
transmitting an information request that includes the UUID and a role-based information control (RBIC) identifier to a remote access control system via a second type of network;
storing, responsive to receiving UUID information in response to the information request, the UUID information on a computer readable storage medium, wherein the UUID information is associated with the UUID, and wherein the UUID information has been filtered based on the RBIC;
detecting a change to the current location;
determining that the current location exceeds the threshold proximity to the proximity device; and
deleting, automatically responsive to determining that the current location exceeds the threshold proximity, the UUID information from the computer readable storage medium.

2. The computer-implemented method according to claim 1, wherein the determining that the current location is within the threshold proximity comprises receiving a radio frequency signal from the proximity device.

3. The computer-implemented method according to claim 2, further comprising extracting a unique device identifier (UDID) associated with the proximity device from the radio frequency signal.

4. The computer-implemented method according to claim 3, further comprising determining, responsive to receiving the UDID, that the UDID is included in a list of known UDIDs.

5. The computer-implemented method according to claim 4, further comprising transmitting, responsive to determining that the UDID is included in a list of known UDIDs, a UDID acknowledgment signal to the proximity device.

6. The computer-implemented method according to claim 5, wherein the UUID is received responsive to the transmitting of the UDID acknowledgement signal.

7. The computer-implemented method according to claim 1, further comprising extracting a UUID information rule from the UUID information, wherein the UUID information rule is based at least in part on the RBIC.

8. The computer-implemented method according to claim 7, wherein the UUID information rule specifies that the UUID information can be shared with a third party.

9. The computer-implemented method according to claim 1, further comprising disabling, responsive to receiving the UUID information, screenshot functionality.

10. The computer-implemented method according to claim 9, further comprising enabling, responsive to deleting the UUID information, screenshot functionality.

11. The computer-implemented method according to claim 1, wherein the RBIC is based at least in part on a job classification.

12. The computer-implemented method according to claim 1, wherein the proximity device does not permit storage of the UUID information.

13. The computer-implemented method according to claim 1, wherein the first type of network is a wireless personal area network (WPAN).

14. The computer-implemented method according to claim 13, wherein the second type of network is larger than the WPAN.

15. A computer program product comprising one or more computer readable storage media, and program instructions collectively stored on the one or more computer readable storage media, the program instructions executable by a processor to cause the processor to perform operations comprising:
determining that a current location is within a threshold proximity to a proximity device;
extracting a unique user identifier (UUID) from data received from the proximity device via a first type of network;
transmitting an information request that includes the UUID and a role-based information control (RBIC) identifier to a remote access control system via a second type of network;
storing, responsive to receiving UUID information in response to the information request, the UUID information on the one or more computer readable storage media, wherein the UUID information is associated with the UUID, and wherein the UUID information has been filtered based on the RBIC;
detecting a change to the current location;
determining that the current location exceeds the threshold proximity to the proximity device; and
deleting, automatically responsive to determining that the current location exceeds the threshold proximity, the UUID information from the computer readable storage medium.

16. The computer program product of claim 15, wherein the stored program instructions are stored in a computer readable storage device in a data processing system, and wherein the stored program instructions are transferred over a network from a remote data processing system.

17. The computer program product of claim 15, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

18. The computer program product of claim 15, wherein the operations further comprise extracting a unique device identifier (UDID) associated with the proximity device from a radio frequency signal received from the proximity device.

19. The computer program product of claim 18, wherein the operations further comprise determining, responsive to receiving the UDID, that the UDID is included in a list of known UDIDs.

20. A computer system comprising a processor and one or more computer readable storage media, and program instructions collectively stored on the one or more computer readable storage media, the program instructions executable by the processor to cause the processor to perform operations comprising:
determining that a current location is within a threshold proximity to a proximity device;
extracting a unique user identifier (UUID) from data received from the proximity device via a first type of network;
transmitting an information request that includes the UUID and a role-based information control (RBIC) identifier to a remote access control system via a second type of network;
storing, responsive to receiving UUID information in response to the information request, the UUID information on the one or more computer readable storage media, wherein the UUID information is associated with the UUID, and wherein the UUID information has been filtered based on the RBIC;
detecting a change to the current location;
determining that the current location exceeds the threshold proximity to the proximity device; and
deleting, automatically responsive to determining that the current location exceeds the threshold proximity, the UUID information from the computer readable storage medium.
